(19) United States
(12) Patent Application Publication
(10) Pub. No.: US 2024/0083527 A1
(43) Pub. Date: Mar. 14, 2024

(54) ALIGNMENT SYSTEM FOR APPROACHING A VEHICLE TO A TARGET OBJECT SPATIALLY SPACED THEREFROM

(71) Applicant: JOST-WERKE DEUTSCHLAND GMBH, Neu-Isenburg (DE)

(72) Inventors: Mark MÜLLER, Frankfurt (DE); Benjamin KAUFHOLD, Seeburg (DE); Steffen HABER, Gross-Gerau (DE); Stephan GITZEN, Riedstadt (DE); Yurtsever ENDER, Dreieich (DE); Daniel JACOBS, Rödermark (DE)

(21) Appl. No.: 18/462,750

(22) Filed: Sep. 7, 2023

(30) Foreign Application Priority Data
Sep. 9, 2022 (DE) 102022003318.6

(51) Int. Cl. B62D 53/12; B60Q 9/00; E02F 3/36

(52) U.S. Cl. CPC B62D 53/12; B60Q 9/00; E02F 3/3604

(57) ABSTRACT

An alignment system for approaching a vehicle to a target object spatially spaced therefrom, including an object detection device attached to the vehicle and a coupling element, which in an end position detachably holds the target object, the object detection device being aligned in the direction of the target object and the data from the object detection device being used to generate an image in which the target object together with a guide marker can be seen during the approach of the vehicle. The guide marker is applied to at least one component of the vehicle arranged in an entry area of the coupling element.

### FIELD OF THE INVENTION

The invention relates to an alignment system for approaching a vehicle to a target object spatially spaced therefrom, comprising an object detection means attached to the vehicle and a coupling element, which in an end position detachably holds the target object, the object detection means being aligned in the direction of the target object and the data from the object detection means being used to generate an image in which the target object together with a guide marker can be seen during the approach of the vehicle.

The object detection means can in particular be a camera, with the help of which the driver is provided with an image of the rear traffic area together with the target object parked there in the driver's cab when the vehicle approaches a target object. With the help of the image, the towing vehicle can be maneuvered more precisely towards the target object.

### BACKGROUND OF THE INVENTION

Document EP 2 987 663 A1 describes a driver assistance system for a commercial vehicle combination as a tractor-trailer combination, consisting of a towing vehicle and a semi-trailer, or as an articulated combination, consisting of a towing vehicle and a trailer. A video camera is attached to the towing vehicle, the video image of which is displayed on a screen arranged in the driver's field of vision. The video camera is mounted in the direction of travel in front of or in the coupling-receiving part on the towing vehicle such that both an area of the coupling-receiving part and a rear area with the coupling element of the semi-trailer or trailer can be seen in the video image. In addition, a guide marker is superimposed on the video image as a direction finder aid, with the help of which a coupling process should be carried out safely, quickly and conveniently. However, it has turned out to be time-consuming to have to specifically program the displayed guide marker depending on the geometric conditions of the towing vehicle and coupling-receiving part as well as the coupling element.

Another prior art is represented by DE 10 2019 201 572 A1 with a guidance system for attaching a working implement to a tractor. A camera is mounted on the tractor, with a reference guide having an edge placed directly in front of the lens. The lens of the camera is configured such that both the edge and implement connections are visible in the image so that the rearward distance to the implement can be better estimated.

Document DE 10 2004 008 928 A1 discloses a method for coupling a trailer using means of a vehicle level control. A reversing camera is attached above a trailer hitch arranged at the rear of the vehicle, which captures the trailer hitch and the rear driving space as well as any trailer that may be parked there. With the help of the reversing camera, the vehicle can be maneuvered backwards close to the trailer and then lowered using the vehicle level control so that the trailer-side counterpart of the coupling does not have to be raised for mechanical coupling.

Document DE 20 2009 018 636 U1 proposes a target device as a coupling aid for a vehicle and a trailer. The target device comprises a rod which can be placed on the ball head of a trailer hitch and has a laser light source which is attached to it at the end and radiates to the rear. A rod with a target body attached to it at the end with a marking is also attached to the drawbar of the trailer by means of a magnetic base. When the vehicle is approaching from behind, the point of impact of the laser on the marking of the target body is visible and can be used for improved maneuvering in the direction of the trailer. Immediately before mechanically connecting the coupling halves, the aiming device must be disassembled.

Document WO 2009/006 529 A1 concerns an electronic trailer hitch system with a stereo camera that is preferably attached to the trailer hitch and has at least two image sensors, and with a processor that processes the image data from the image sensors. With the help of the evaluated image data, the towing vehicle is to approach the trailer vehicle autonomously.

The common disadvantage of prior art maneuvering aids is that they are difficult to install and require additional handling by the driver during use.

### SUMMARY OF THE INVENTION

For this reason, the object of the invention was to develop a technically simpler solution for displaying a guide marker.

The object is solved with an alignment system for approaching a vehicle to a target object spatially spaced therefrom, comprising an object detection means attached to the vehicle and a coupling element, which in an end position detachably holds the target object, the object detection means being aligned in the direction of the target object and the data from the object detection means being used to generate an image in which the target object together with a guide marker can be seen during the approach of the vehicle, wherein the guide marker is applied to at least one component of the vehicle arranged in an entry area of the coupling element.

An object detection means is understood to mean, for example, a camera which can operate in the non-visible range, for example in the infrared range, and/or in the visible spectrum. In addition to 2D image sensors, imaging sensors that can capture 3D information are also suitable. These include in particular laser scanners, radar sensors and ultrasonic sensors. For better protection against external influences, the object detection means can comprise a housing and preferably form a common structural unit with it.

The object detection means is fixed stationary with respect to the guide marker and is aligned with it. The entry area is a section in front of the coupling element which the target object passes while approaching the coupling element. The target object changes its position relative to the guide marker as it approaches in the longitudinal axis of the vehicle.

The entry area is arranged in particular on the side of the coupling element being spaced apart from the object detection means. This results in a sequence of object detection means, preferably coupling element, and guide marker in the longitudinal axis in the direction of the target object.

The image provided by the object detection means can be displayed on a display device in the driver's cab and can be used by the driver as a visual maneuvering aid for coupling the trailer vehicle. However, it is also possible for the data provided by the object detection means to be fed into the electronic data system of the towing vehicle without displaying the image, so that the towing vehicle carries out an autonomous or semi-autonomous coupling of the trailer vehicle on the basis of this data. A semi-autonomous coupling is meant to be an assistance system for the driver to provide support during maneuvering.

Advantageously, the guide marker is physically permanent. For this purpose, it has proven to be particularly favorable if the guide marker is painted, glued, embossed, milled and/or designed to protrude from the component in a relief-like manner on the component.

According to a particularly expedient embodiment, the guide marker comprises at least one directional element mounted rigidly or movably on the component. A rigid directional element may have one or more upstanding pedestals, recesses or ridges. If two of these directional elements are arranged in the direction of the end position of the target object and/or in alignment with the object detection means, a bearing line results on which the vehicle can approach the target object.

A further preferred embodiment consists in that the guide marker is projected onto the component by means of a light source. In this embodiment, the guide marker exists only temporary. The guide marker appears or disappears by switching the light source on or off. This is advantageous in that the guide marker only needs to be switched on immediately before the coupling element and the target object are brought together. No painting or gluing work on components of the vehicle is necessary. The light source can be a lamp with a screen designed in the form of the guide marker, a projector or a laser pointer. Complex guide markings can be generated using holographic optics.

It makes sense for the guide marker to be formed from at least one boundary line running towards the end position of the target object and/or towards the object detection means. The boundary line delimits the intended travel path of the target object, in particular in the direction of the transverse axis. For an accurate connection of the coupling element with the target object, the target object must always be kept between the boundary line(s) while the vehicle is approaching.

The boundary line(s) can be conically widened or tapered in the distal direction. A boundary line that widens conically in the distal direction has the advantage that the target object can initially be easily placed within the boundary line and is positioned more precisely as it gets closer. A boundary line that tapers conically in the distal direction, on the other hand, is advantageous because the target object is also perceived as smaller with greater distance from the object detection means due to a constant focal length and grows with decreasing distance together with the boundary line in the image plane.

Advantageously, the guide marker is formed in accordance with a contour of the target object or is obtained taking into account a perspective distortion. The contour of the target object depicted as a guide marker is preferably congruent with the target object when the target object is passed or at least specifies a size framework within which the target object must be located for accurate contacting with the coupling element.

The guide marker advantageously extends in an x-y plane (horizontal), y-z plane (vertical in the direction of movement) and/or x-z plane (transverse to the direction of movement) or at least has sections that extend over at least two of these planes.

An electronic control unit can be present, with which a distance to the target object is determined from the ratio of a known size of the guide marker and a known size of the target object. In this embodiment, the distance in the longitudinal axis can be derived from the size ratio of the guide marker and the target object.

According to an advantageous embodiment, the coupling element is a fifth wheel and the target object is a kingpin attached to a second vehicle. In this embodiment, the vehicle is a towing vehicle and the second vehicle is a semi-trailer.

The component is formed in particular from opposite flanks of coupling horns arranged to the side of the entry area. These flanks form a conically tapering entry area, which guides the kingpin in the event of a slight lateral misalignment. A guide marker applied to the flanks of the coupling horns allows the vehicle to be driven more precisely to the kingpin.

It is also possible for the component to be formed from a cross bridge arranged under the entry area. The cross bridge can run completely under the entry area of the fifth wheel and be connected on both sides to the underside of the coupling plate, which considerably increases the strength of the fifth wheel. In principle, it would also be possible to connect the cross bridge to the coupling plate on one side only and to use it as a holder for the guide marker.

A further alternative configuration can consist in the component being formed from a connector console of an automated plug-in coupling system for supply lines arranged under the entry area. The connector console is located under the entry area of the fifth wheel so that a kingpin can drive over the connector console. The connector console has a housing, the top of which is suitable as a component of the vehicle for applying a guide marker.

However, the coupling element can also be a container lock and the target object can be a corner fitting formed on a container or a swap body. With the help of the guide marker arranged on a component of the vehicle, the vehicle can be maneuvered particularly precisely onto the container or swap body, so that the corner fitting is hit by the associated container lock.

It is also possible for the coupling element to be a guiding roller and for the target object to be a guide frame formed on a swap body. The guiding roller engages with a guide frame formed on the underside of the container or swap body when the vehicle approaches in the rearward direction. This guide frame is to be brought into the guide marker as the vehicle approaches. The component with the guide marker is then typically formed from a vehicle frame part or a chassis component of the vehicle.

According to a further embodiment, the coupling element can be a tool holder arranged on the distal end of a front loader and the target object can be a pick-up implement of a working device to be fastened to the front loader. An implement is, for example, a shovel or fork. The implement can typically be removed from the front loader and replaced with another via a quick-change system. Since the space around the distal end of the front loader can hardly be seen from the driver's seat, the vehicle can be driven up to the implement by means of the object detection means until its pick-up implement has moved into the guide marker. In this embodiment, it is possible for the component to be formed from the tool holder.

### BRIEF DESCRIPTION OF THE DRAWINGS

For better understanding, the invention is explained in more detail below with reference to 15 Figures, which show in

FIG. 1: a plan view of a coupling element in the form of a fifth wheel with a guide marker arranged on the flanks of the coupling horns;

FIG. 2: a plan view of a coupling element in the form of a fifth wheel with a guide marker arranged on a cross bridge;

FIG. 3: a plan view of a coupling element in the form of a fifth wheel with a guide marker arranged in the transition area between the cross bridge and flanks of the coupling horns;

FIG. 4: a plan view of a coupling element in the form of a fifth wheel with a guide marker arranged on a connector console;

FIG. 5: is an enlarged plan view of a locking portion of a fifth wheel with a broken line guide marker disposed on a cross bridge;

FIG. 6: is an enlarged plan view of a locking portion of a fifth wheel with a trapezoidal guide marker disposed on a cross bridge;

FIG. 7: an enlarged plan view of a locking section of a fifth wheel with a guide marker arranged on a cross bridge with the contour of the target object;

FIG. 8: is an enlarged plan view of a locking portion of a fifth wheel with a guide marker projected from a light source onto the cross bridge;

FIG. 9: an enlarged top view of a locking portion of a fifth wheel with a guide marker arranged on a cross bridge in the form of two boundary lines diverging conically in the direction of the object detection means;

FIG. 10: an enlarged top view of a locking section of a fifth wheel with a guide marker arranged on a cross bridge in the form of two boundary lines conically converging in the direction of the object detection means;

FIG. 11: a plan view of a coupling element in the form of a fifth wheel with a guide marker arranged on a cross bridge in the form of a directional element according to a first embodiment;

FIG. 12: a plan view of a coupling element in the form of a fifth wheel with a guide marker arranged on a cross bridge in the form of a directional element according to a second embodiment;

FIG. 13: a plan view of a vehicle with a guide marker on the vehicle frame and chassis component before receiving a swap body;

FIG. 14: a side view of a front loader with working device; and

FIG. 15: a perspective front view of the front loader with object detection means without working device.

### DETAILED DESCRIPTION OF THE INVENTION

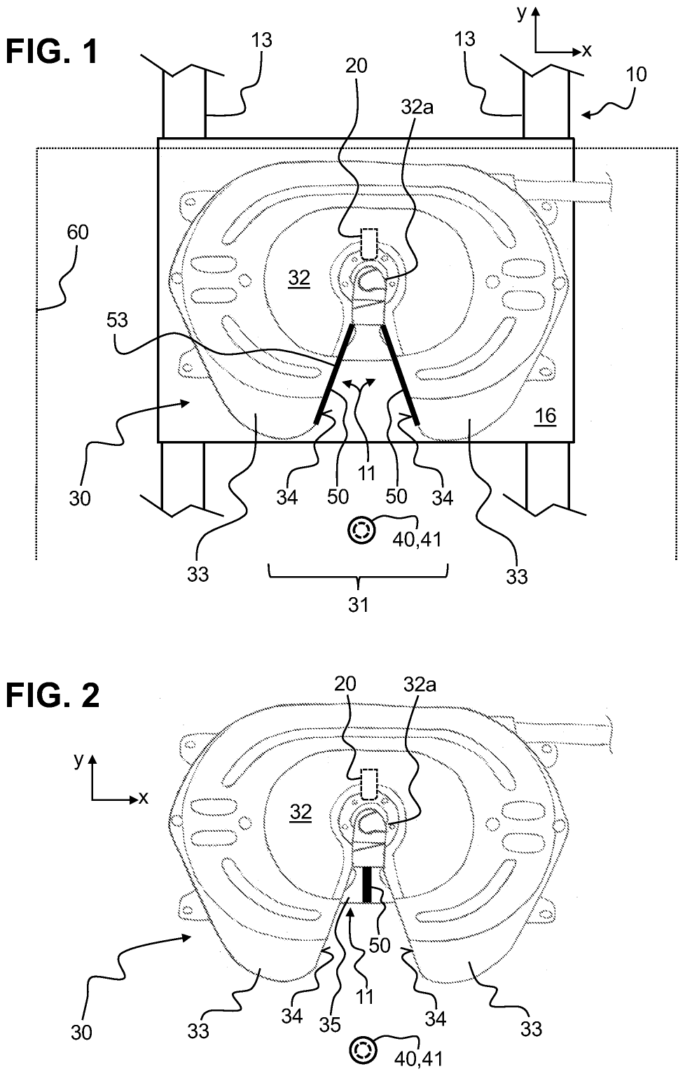

FIG. 1 shows a top view of a coupling element 30 in the form of a fifth wheel 32 which is fastened to vehicle frame parts 13 of a vehicle 10 by means of a mounting plate 16. The vehicle 10 is in particular a towing vehicle for a semi-trailer.

The vehicle 10 has approached a second vehicle 60, in particular a semi-trailer, backwards in a longitudinal axis y. The longitudinal axis y corresponds to the direction of travel when the vehicle 10 is traveling straight ahead. The second vehicle 60 is shown schematically as a dotted line and already overlaps the vehicle 10 along with its fifth wheel 32. On the underside, the second vehicle 60 has a target object 40 in the form of a king pin 41 protruding downward.

The fifth wheel 32 is formed on its side facing the kingpin 41 with two coupling horns 33 whose flanks 34 facing one another span a V-shaped entry area 31 within the contour of the fifth wheel 32. In the rearward direction, the entry area 31 continues as an extension of the flanks 34. The entry area 31 ends in the longitudinal axis y in a locking portion 32a of the fifth wheel 32, in which the kingpin 41 is detachably connected to the fifth wheel 32 after it has reached its end position.

In order to couple the second vehicle 60, the vehicle 10 must approach it in such a way that the kingpin 41 enters an entry area 31 of the fifth wheel 32 in the longitudinal axis x with the smallest possible offset in the transverse axis x. This approach is facilitated by means of an object detection means 20 used, for example, in the longitudinal axis y of the locking portion 32a, in the field of view of which the second vehicle 60 with the kingpin 41 is already visible when the vehicle 10 is roughly aligned.

In addition, a guide marker 50 is applied to a component 11 arranged in the entry area 31 in such a way that it is also detected by the object detection means 20. In the embodiment of FIG. 1, the guide marker 50 is permanently applied to the two facing flanks 34 of the coupling horns 33 as a high-contrast paint finish compared to the fifth wheel 32. In particular, the guide marker 50 can occupy the entire surface of the respective flank 34. For an accurate coupling of the kingpin 41, the driver only needs to keep the kingpin 41 within the guide marker 50 while reversing, i.e. between the high-contrast surfaces of the flanks 34.

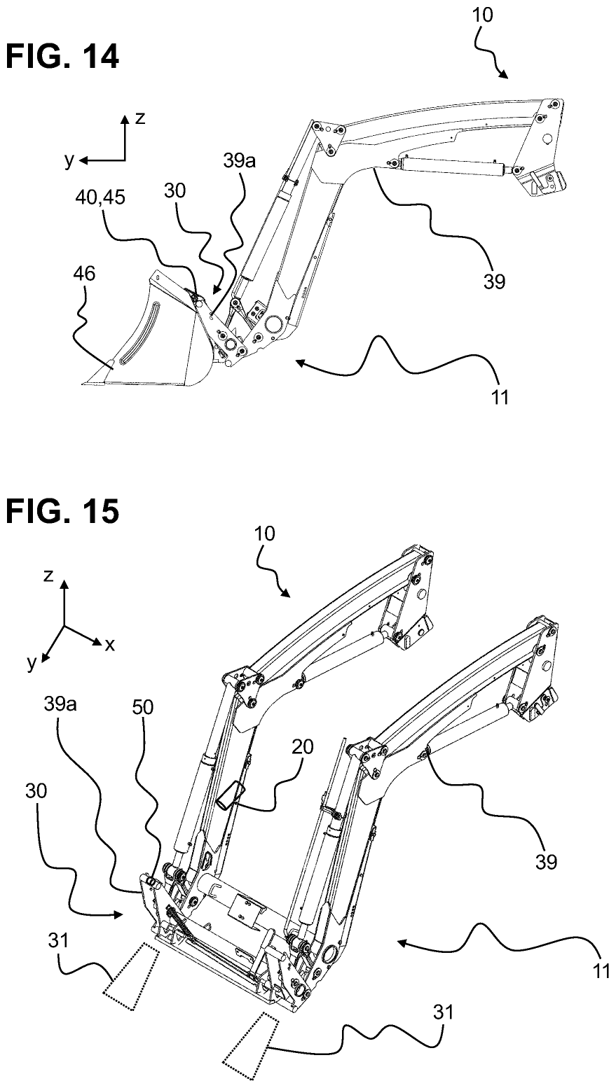

FIG. 2 shows an alternative exemplary embodiment, in which the component 11 carrying the guide marker 50 is formed from a cross bridge 35 arranged on the fifth wheel 32. The cross bridge 35 is located in the transition from the entry area 31 to the locking portion 32a in a vertical axis z (compare FIG. 14, FIG. 15) below a level of the entry area 31, so that a kingpin 41 moving into the fifth wheel 32 can drive over the cross bridge 35 without colliding. The cross bridge 35 can engage the fifth wheel 32 on both sides of the entry area 31 to stiffen it.

The guide marker 50 is applied to the cross bridge 35 as a continuous line running in the longitudinal axis y. Both the cross bridge 35 and the guide marker 50 applied to it are in the field of view of the object detection means 20. During the approach of the vehicle 10 (see FIG. 1), it is desired that the kingpin 41 detected by the object detection means 20 is kept as centered as possible with respect to the guide marker 50 by appropriate steering maneuvers.

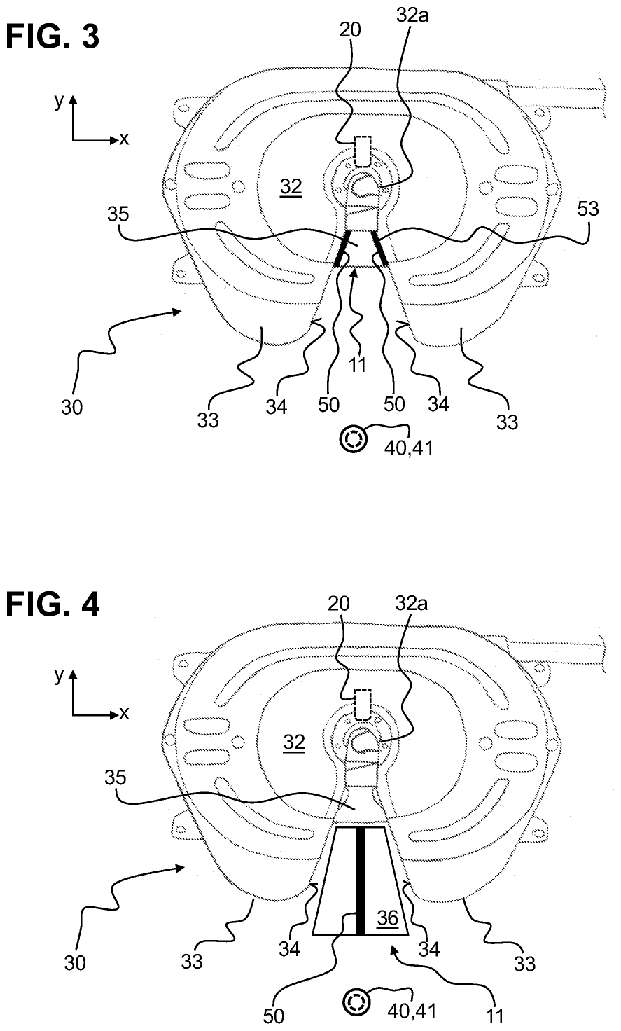

FIG. 3 shows a further exemplary embodiment, in which the guide marker 50 is also applied to the cross bridge 35 as a component 11. However, the guide marker 50 comprises two boundary lines 53 that diverge conically in the rearward direction along the longitudinal axis y and are bounded laterally outward by the flanks 34 of the coupling horns 33. Both boundary lines 53 are in the field of view of object detection means 20. For accurate coupling of kingpin 41, it must be positioned between the two boundary lines 53 during the approach of the vehicle 10.

FIG. 4 shows an alternative exemplary embodiment with a connector console 36 of an automatic plug-in coupling system for supply lines arranged under the entry area 31. During the coupling, the approaching kingpin 41 first passes over the connector console 36 without contact and then connects it to a plug bracket on the trailer side, which is not shown here. The component 11 that carries the guide marker 50 is the connector console 36. The guide marker 50 is applied to the upper side of the connector console 36, which is oriented upwards in the vertical axis z, and is therefore in the field of view of the object detection means 20.

The guide marker 50 is formed as a continuous line aligned in the longitudinal axis y, which runs completely over the connector console 36. An approaching kingpin 41 should be kept as centered as possible above the line of the guide marker 50 by steering maneuvers of the vehicle 10.

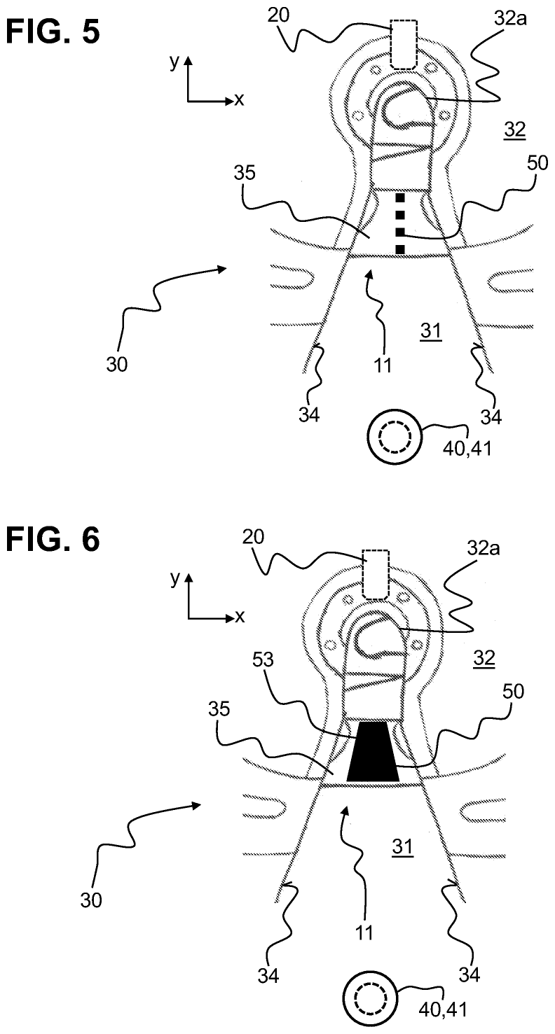

FIG. 5 shows an enlarged section of the locking portion 32a of a fifth wheel 32 together with the cross bridge 35. The guide marker 50 is similar to the embodiment in FIG. 2 applied to the cross bridge 35.

Deviating from this, however, a broken or dotted line was chosen as the guide marker 50 instead of a continuous line lying in the longitudinal axis y.

FIG. 6, in the same view as FIG. 5, shows another embodiment of the guide marker 50 applied to the cross bridge 35 in a trapezoidal shape. The two diverging sides of the guide marker 50 are each aligned essentially equidistant to the flanks 34 of the coupling horns 33 and form a boundary line 53 in the direction of the transverse axis x for the kingpin 41. During the approach of the vehicle 10 to the kingpin 41, the latter should preferably be held between the opposite boundary lines 53.

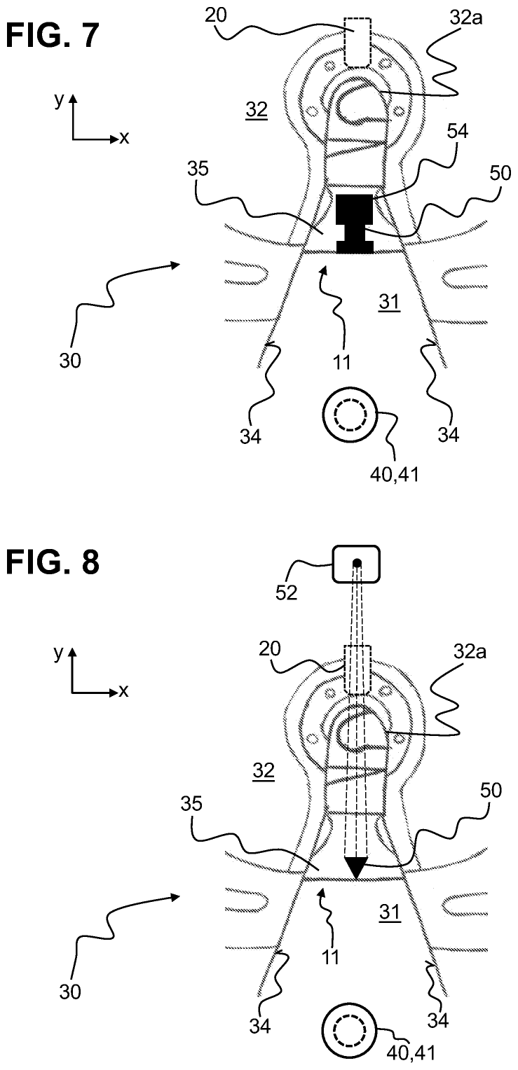

FIG. 7 shows the same view as FIG. 5 and FIG. 6. The guide marker 50 is also here applied to the cross bridge 35 and is thereby visible from the object detection means 20. However, guide marker 50 has a simplified contour of target object 40, in the present exemplary embodiment that of kingpin 41. As vehicle 10 approaches the kingpin 41, it should be aligned as closely as possible with the identically shaped guide marker 50 as is passes the cross bridge 35.

In the embodiment according to FIG. 8, a temporarily visible guide marker 50 is shown, which is thrown onto the cross bridge 35 chosen as component 11 by means of visible light by means of a light source 52 located higher in the vertical axis z. After the kingpin 41 has been successfully coupled, the light source 52 can be switched off so that the guide marker 50 is no longer visible.

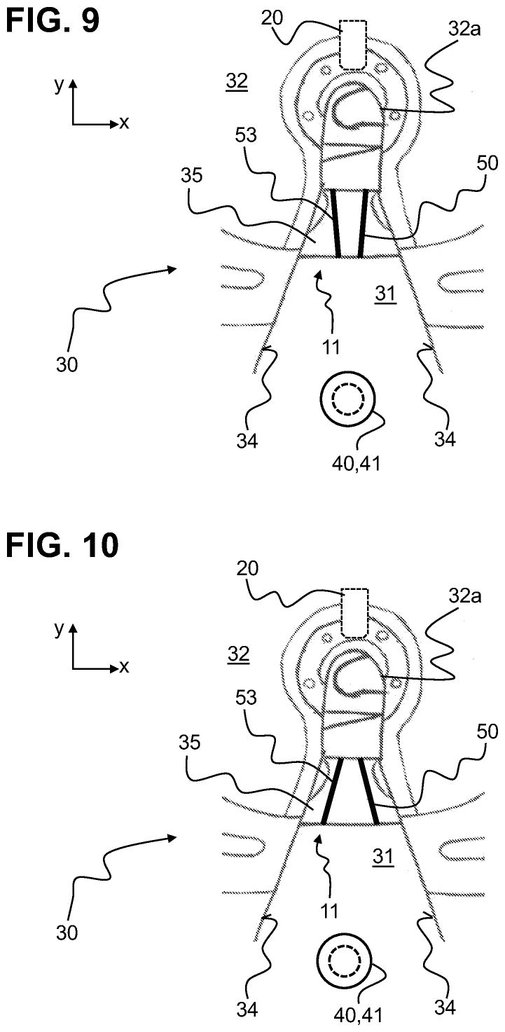

FIG. 9 shows a guide marker 50 applied to the cross bridge 35 as component 11, which is formed from two boundary lines 53 tapering in the direction of the locking portion 32a, between which the kingpin 41 is intended to be positioned during coupling. In FIG. 10, the guide marker 50 formed from two boundary lines 53 converge conically in the direction of the locking portion 32a.

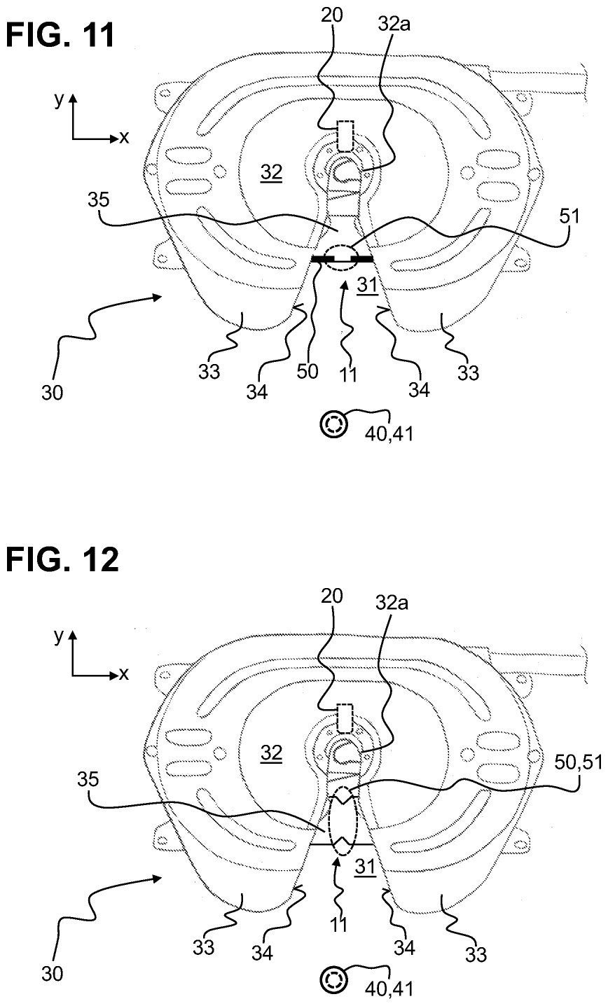

FIG. 11 relates to a further, alternative embodiment with a guide marker 50 formed on the cross bridge 35 in the form of a directional element 51. The directional element 51 comprises two wall sections extending along the transverse axis x and upright with respect to the cross bridge 35, and a recess formed therein along the longitudinal axis y. Both the wall sections and the recess are visible from the object detection means 20 when approaching the kingpin 41. While the vehicle 10 is approaching, it should be maneuvered in such a way that the kingpin 41 is visible behind the recess in the image generated by the object detection means 20.

FIG. 11 illustrates a second embodiment of a guide marker 50 with two directional elements 51. The guide marker 50 is formed from two directional elements 51 formed in the cross bridge 35 and aligned with one another in the longitudinal axis y, which are, for example, recess(es) and/or elevation(s). During the approach, the target object 40 in the form of the kingpin 41 is sighted according to the principle of notch and bead sighter in an extension of the two directional elements 51.

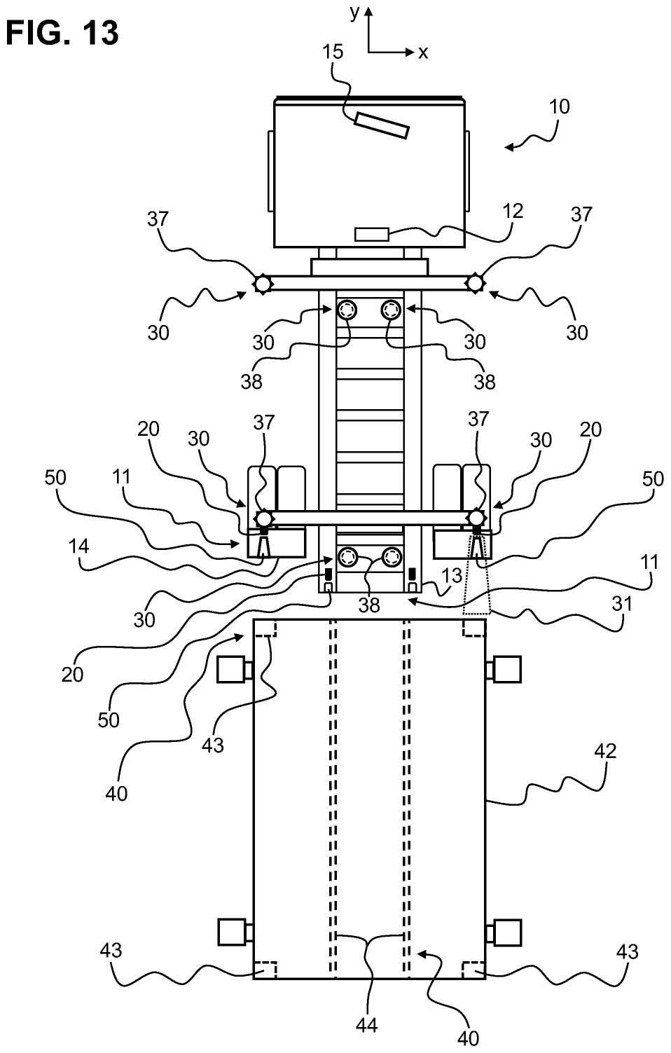

FIG. 13 shows a vehicle 10 for transporting a container or swap body 42 parked behind it.

The vehicle 10 has, as a coupling element 30, a plurality of container locks 37 which, when a container or swap body 42 has been correctly picked up, dip into corner fittings 43 provided therein and hold it releasably during transport. The target object 40 in such a vehicle 10 may be the corner fittings 43 of the container or swap body 42. In order to be able to approach theses as precisely as possible, an object detection means 20 is mounted in spatial proximity to at least one of the container locks 37, which detects an entry area 31 oriented behind the vehicle 10 and in the direction of the nearest corner fitting 43. A guide marker 50 is applied between the object detection means 20 and the target object 40 on a component 11 in the form of a chassis component 14, which can also be a mudguard or another covering part. When the vehicle 10 is reversing in the direction of the stationary container or swap body 42, maneuvering should be carried out in such a way that the target object 40 in the form of one of the corner fittings 43 is positioned in prolongation within the contour of the guide marker 50.

The target object 40 can also be a guide frame 44 running parallel to the longitudinal axis y on the underside of the container or swap body 42 instead of one or more of the corner fittings 43. While the container or swap body 42 is being picked up, this guide frame 44 comes into active engagement with a coupling element 30 of the vehicle 10 in the form of guiding rollers 38. The guiding rollers 38 are rotatably mounted about the vertical axis z and are located within the guide frame 44 when the container or swap body 42 is loaded. For an exact approach of the guide frame 44, an object detection means 20 is mounted on a vehicle frame part 13 in spatial proximity to at least one of the guiding rollers 38, the field of view of which is aligned in the direction of the container or swap body 42. A guide marker 50 attached to vehicle frame part 13 is also located in the field of view of the object detection means 20.

A display device 15 is arranged in the vehicle 10 within sight of the driver and displays a visible image of the target object 40, in particular the corner fitting 43 and/or the guide frame 44, relative to the guide marker 50.

FIG. 14 and FIG. 15 show the alignment system on a front loader 39, the coupling element 30 of which is a tool holder 39a for releasably attaching a working device 46, such as a shovel. As a target object 40, the working device 46 has a pick-up implement 45 that is complementary to the tool holder 39a and into which the tool holder 39a can be maneuvered accurately.

Maneuvering is simplified by means of the guide marker 50 attached to the tool holder 39a, which is in the field of view of the object detection means 20 arranged on the front loader 39. During the approach to the working device 46 only the pick-up implement 45 has to be brought into the contour of the guide marker 50.

### LIST OF REFERENCE NUMERALS

10 vehicle
11 component
12 control unit
13 vehicle frame part
14 chassis component
15 display device
16 mounting plate
20 object detection means
30 coupling element
31 entry area
32 fifth wheel
32a locking portion
33 coupling horns
34 flank coupling horn
35 cross bridge
36 connector console
37 container lock
38 guiding roller
39 front loader
39a tool holder
40 target object
41 kingpin
42 container/swap body
43 corner fitting container/swap body
44 guide frame
45 pick-up implement
46 working device
50 guide marker
51 directional element
52 light source
53 boundary line
54 directional element with contour target object
60 second vehicle
x transverse axis
y longitudinal axis
z vertical axis

What is claimed is:

1. An alignment system for approaching a vehicle to a target object spatially spaced therefrom, comprising:
an object detection means attached to the vehicle and
a coupling element, which in an end position detachably holds the target object,
the object detection means being aligned in the direction of the target object and the data from the object detection means being used to generate an image in which the target object together with a guide marker can be seen during the approach of the vehicle,
wherein the guide marker is applied to at least one component of the vehicle arranged in an entry area of the coupling element.

2. The alignment system according to claim 1, wherein the guide marker exists physically permanent.

3. The alignment system according to claim 1, wherein the guide marker on the component is painted, glued, embossed, milled and/or is formed on the component as a protruding relief.

4. The alignment system according to claim 1, wherein the guide marker comprises at least one directional element mounted rigidly or movably on the component.

5. The alignment system according to claim 1, wherein the guide marker is projected onto the component by means of a light source.

6. The alignment system according to one of claim 1, wherein the guide marker is formed from at least one boundary line running towards an end position of the target object and/or towards the object detection means.

7. The alignment system according to claim 6, wherein the at least one boundary line is formed conically widened or tapered in the distal direction.

8. The alignment system according to claim 1, wherein the guide marker is formed in accordance with a contour of the target object or is obtained taking into account a perspective distortion.

9. The alignment system according to claim 1, wherein the guide marker extends in an x-y plane (horizontal), y-z plane (vertical in the direction of movement) and/or x-z plane (transverse to the direction of movement) or at least has sections that extend over at least two of these planes.

10. The alignment system according to claim 1, wherein there is an electronic control unit which determines a distance to the target object from the ratio of a known size of the guide marker and a known size of the target object.

11. The alignment system according to claim 1, wherein the coupling element is a fifth wheel and the target object is a kingpin attached to a second vehicle.

12. The alignment system according to claim 11, wherein the component is formed from opposite flanks of coupling horns arranged to the side of the entry area.

13. The alignment system according to claim 11, wherein the component is formed from a cross bridge arranged under the entry area.

14. The alignment system according to claim 11, wherein the component is formed from a connector console of an automated plug-in coupling system for supply lines arranged under the entry area.

15. The alignment system according to claim 1, wherein the coupling element is a container lock and the target object is a corner fitting formed on a container or a swap body.

16. The alignment system according to claim 1, wherein the coupling element is a guiding roller and the target object is a guide frame formed on a swap body.

17. The alignment system according to claim 15, wherein the component is formed from a vehicle frame part or a chassis component of the vehicle.

18. The alignment system according to claim 1, wherein the coupling element is a tool holder arranged on the distal end of a front loader and the target object is a pick-up implement of a working device which has to be attached on the front loader.

19. The alignment system according to claim 18, wherein the component is formed from a section of the distal end of the front loader which is aligned to the tool holder.
